(19) United States
(12) Patent Application Publication
(10) Pub. No.: US 2025/0381970 A1
(43) Pub. Date: Dec. 18, 2025

(54) VEHICLE OPERATION

(71) Applicant: Ford Global Technologies, LLC, Dearborn, MI (US)

(72) Inventors: David Hancock, South Rockwood, MI (US); Scott Steadmon Thompson, Belleville, MI (US); John Eric Rollinger, Troy, MI (US); Steven T. Skikun, Northville, MI (US); Matthew Ryan Preston, Whitmore Lake, MI (US)

(73) Assignee: Ford Global Technologies, LLC, Dearborn, MI (US)

(21) Appl. No.: 19/180,357

(22) Filed: Apr. 16, 2025

Related U.S. Application Data
(60) Provisional application No. 63/647,704, filed on May 15, 2024.

(51) Int. Cl. B60W 50/12; B60W 30/182

(52) U.S. Cl. CPC B60W 50/12; B60W 30/182; B60W 2510/1005; B60W 2530/18

(57) ABSTRACT

A key cycle is detected that engages a vehicle from an off state to an on state. A standard operation mode of the vehicle is disables based on an odometer value being greater than or equal to a first threshold. The standard operation mode specifies default operating parameters of the vehicle. Upon disabling a standard operation mode of the vehicle, the vehicle is operated in a first limited operation mode specifying first limited operating parameters. The respective first limited operating parameters are less than the respective default operating parameters.

### CROSS-REFERENCE TO RELATED APPLICATION

This patent application claims priority to U.S. Provisional Patent Application No. 63/647,704 filed on May 15, 2024, which is hereby incorporated by reference in its entirety.

### BACKGROUND

A vehicle can be equipped with electronic and electro-mechanical components, (e.g., computing devices, networks, sensors and controllers, etc.). A vehicle computer can acquire data regarding the vehicle's environment and can operate the vehicle or at least some components thereof based on the data. Vehicle sensors can provide data concerning routes to be traveled and objects to be accounted for in the vehicle's environment.

### BRIEF DESCRIPTION OF THE DRAWINGS

FIG. 1 is a block diagram illustrating an example vehicle control system.

FIG. 2A is a first part of a flowchart of an example process for operating a vehicle.

FIG. 2B is a second part of the flowchart of FIG. 2A.

FIG. 2C is a third part of the flowchart of FIG. 2A.

### DETAILED DESCRIPTION

A system includes a computer including a processor and a memory, the memory storing instructions executable by the processor to detect a key cycle that engages a vehicle from an off state to an on state. The instructions further include instructions to disable a standard operation mode of the vehicle based on an odometer value being greater than or equal to a first threshold. The standard operation mode specifies default operating parameters of the vehicle. The instructions further include instructions to, upon disabling a standard operation mode of the vehicle, operate the vehicle in a first limited operation mode specifying first limited operating parameters. The respective first limited operating parameters are less than the respective default operating parameters. For example, a limited distance operating parameter could be less than a default distance operating parameter, a limited speed operating parameter could be less than a default speed operating parameter, etc.

The instructions can further include instructions to, upon expiration of a timer, transition the vehicle to a second limited operation mode specifying second limited operating parameters. The respective second limited operating parameters may be greater than the respective first limited operating parameters. The respective second limited operating parameters may be less than the respective default operating parameters. The instructions can further include instructions to initiate the timer upon detecting the key cycle. The instructions can further include instructions to, after transitioning the vehicle to the second limited operation mode, transition the vehicle to the first limited operation mode based on the odometer value reaching a second threshold value. The instructions can further include instructions to prevent operation of the vehicle in the second limited operation mode based on the odometer value reaching a second threshold value.

The instructions can further include instructions to, upon detecting the key cycle, enable the standard operation mode of the vehicle based on the odometer value being less than the first threshold. The instructions can further include instructions to, after enabling the standard operation mode, transition the vehicle to the second limited operation mode based on the odometer value reaching the first threshold.

The instructions can further include instructions to, after enabling the first limited operation mode, enable the standard operation mode based on receiving a user input selecting the standard operation mode. The instructions can further include instructions to enable the standard operation mode based further on detecting a subsequent key cycle. The instructions can further include instructions to enable the standard operation mode based further on expiration of a second timer. The second timer may be initiated upon receiving the user input. The instructions can further include instructions to enable the standard operation mode based further on a location of the vehicle being within a predetermined area.

A method includes detecting a key cycle that engages a vehicle from an off state to an on state. The method further includes disabling a standard operation mode of the vehicle based on an odometer value being greater than or equal to a first threshold. The standard operation mode specifies default operating parameters of the vehicle. The method further includes, upon disabling a standard operation mode of the vehicle, operating the vehicle in a first limited operation mode specifying first limited operating parameters. The respective first limited operating parameters are less than the respective default operating parameters.

The method can further include, upon expiration of a timer, transitioning the vehicle to a second limited operation mode specifying second limited operating parameters. The respective second limited operating parameters may be greater than the respective first limited operating parameters. The respective second limited operating parameters may be less than the respective default operating parameters. The method can further include initiating the timer upon detecting the key cycle. The method can further include, after transitioning the vehicle to the second limited operation mode, transitioning the vehicle to the first limited operation mode based on the odometer value reaching a second threshold value. The method can further include preventing operation of the vehicle in the second limited operation mode based on the odometer value reaching a second threshold value.

The method can further include, upon detecting the key cycle, enabling the standard operation mode of the vehicle based on the odometer value being less than the first threshold. The method can further include, after enabling the standard operation mode, transitioning the vehicle to the second limited operation mode based on the odometer value reaching the first threshold.

The method can further include, after enabling the first limited operation mode, enabling the standard operation mode based on receiving a user input selecting the standard operation mode. The method can further include enabling the standard operation mode based further on detecting a subsequent key cycle. The method can further include enabling the standard operation mode based further on expiration of a second timer. The second timer may be initiated upon receiving the user input. The method can further include enabling the standard operation mode based further on a location of the vehicle being within a predetermined area.

Further disclosed herein is a computing device programmed to execute any of the above method steps. Yet further disclosed herein is a computer program product, including a computer readable medium storing instructions executable by a computer processor, to execute an of the above method steps.

In non-limiting examples, after a vehicle is assembled, but prior to being delivered to a dealership or customer, the vehicle may be operated around an assembly plant (e.g., as part of end-of-line testing and/or quality check procedures) and/or to a temporary holding facility (e.g., to await shipment to the dealership or customer and/or due to inventory constraints at the assembly plant). In these situations, a factory mode or a transport mode may be enabled such that some features (i.e., a setting of a vehicle component (e.g., heating a steering wheel, auto-dimming a rearview mirror, heating side mirrors, etc.) that can be selected by a user) of the vehicle are disabled or limited (e.g., to reduce power consumption by the features by preventing sensors and/or components from drawing power from the battery). However, the vehicle may be operated in a standard operation mode (i.e., based on default operating parameters) regardless of the factory mode or the transport mode being enabled.

As described herein, a vehicle computer can disable a standard operation mode of the vehicle and operate the vehicle in a limited operation mode. The limited operation mode specifies limited operating parameters that are less than default operating parameters specified by the standard operation mode. Operating the vehicle based on limited operating parameters results in vehicle performance being limited relative to operating the vehicle in the standard operation mode, which may deter vehicle theft.

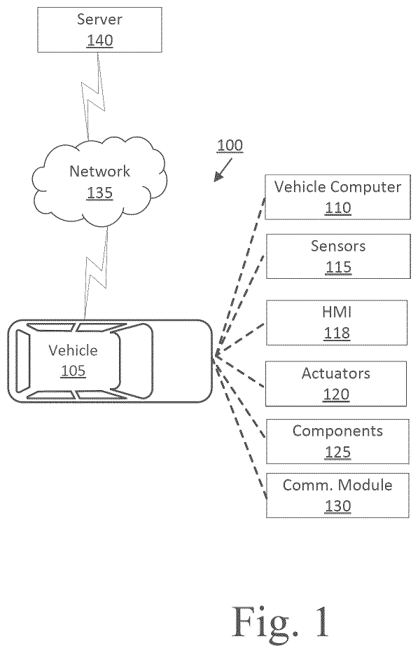

With reference to FIG. 1, an example vehicle control system 100 includes a vehicle 105. A vehicle computer 110 in the vehicle 105 receives data from sensors 115. The vehicle computer 110 is programmed to detect a key cycle that engages the vehicle 105 from an off state to an on state. That is, a key cycle herein means a transition from an off state to an on state. The vehicle computer 110 is further programmed to disable a standard operation mode of the vehicle 105 based on an odometer value reaching (e.g., being greater than or equal to) a first threshold. The standard operation mode specifies default operating parameters of the vehicle 105. The vehicle computer 110 is further programmed to, upon disabling a standard operation mode of the vehicle 105, operate the vehicle 105 in a first limited operation mode specifying first limited operating parameters. The respective first limited operating parameters are less than the respective default operating parameters, that is, specify lesser or more limited operating parameters such as speed or distance parameters.

The vehicle 105 includes the vehicle computer 110, sensors 115, actuators 120 to actuate various vehicle components 125, and a vehicle communications module 130. The communications module 130 allows the vehicle computer 110 to communicate with a remote server computer 140, and/or other vehicles (e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135).

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above, and/or may include an electronic control unit (ECU) or electronic controller or the like for a specific function or set of functions, and/or may include a dedicated electronic circuit including an ASIC that is manufactured for a particular operation (e.g., an ASIC for processing sensor data and/or communicating the sensor data). In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming (e.g. stored in a memory electrically connected to the FPGA circuit). In some examples, a combination of processor(s), ASIC(s), and/or FPGA circuits may be included in the vehicle computer 110.

The vehicle computer 110 may include programming to operate one or more of vehicle 105 propulsion, steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to (e.g., via a vehicle communications network such as a communications bus as described further below) more than one processor (e.g., included in electronic controller units (ECUs) or the like included in the vehicle 105) for monitoring and/or controlling various vehicle components 125 (e.g., a transmission controller, a steering controller, etc.). The vehicle computer 110 is generally arranged for communications on a vehicle communication network that can include a bus in the vehicle 105 such as a controller area network (CAN) or the like, and/or other wired and/or wireless mechanisms.

Via the vehicle 105 network, the vehicle computer 110 may transmit messages to various devices in the vehicle 105 and/or receive messages (e.g., CAN messages) from the various devices (e.g., sensors 115, an actuator 120, ECUs, etc.). Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor(s) 115, etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, second vehicles, etc., relative to the location of the vehicle 105. The sensors 115 may further alternatively or additionally, for example, include camera sensor(s) 115 (e.g. front view, side view, etc.) providing images from an area surrounding the vehicle 105. In the context of this disclosure, an object is a physical (i.e., material) item that has mass and that can be represented by physical phenomena (e.g., light or other electromagnetic waves, or sound, etc.) detectable by sensors 115. Thus, the vehicle 105, as well as other items including as discussed below, fall within the definition of “object” herein.

The vehicle computer 110 is programmed to receive data from one or more sensors 115 substantially continuously, periodically, and/or when instructed by a remote server computer 140, etc. The data may, for example, include a location of the vehicle 105. Location data specifies a point or points on a ground surface and may be in a known form (e.g., geo-coordinates such as latitude and longitude coordinates obtained via a navigation system, as is known, that uses the Global Positioning System (GPS)). Additionally, or alternatively, the data can include a location of an object (e.g., a vehicle, a sign, a tree, etc.) relative to the vehicle 105. As one example, the data may be image data of the environment around the vehicle 105. In such an example, the image data may include one or more objects and/or markings (e.g., lane markings) on or along a road. Image data herein means digital image data (e.g., comprising pixels with intensity and color values) that can be acquired by camera sensors 115. The sensors 115 can be mounted to any suitable location in or on the vehicle 105 (e.g., on a vehicle 105 bumper, on a top of a vehicle 105, etc.) to collect images of the environment around the vehicle 105.

The vehicle 105 actuators 120 are implemented via circuits, chips, or other electronic and or mechanical components that can actuate various vehicle subsystems in accordance with appropriate control signals as is known. The actuators 120 may be used to control components 125, including propulsion and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a park assist component, an adaptive cruise control component, an adaptive steering component, etc.

In addition, the vehicle computer 110 may be configured for communicating via a vehicle-to-vehicle communication module 130 or interface with devices outside of the vehicle 105 (e.g., through a vehicle-to-vehicle (V2V) or vehicle-to-infrastructure (V2X) wireless communications (cellular and/or short-range radio communications, etc.) to another vehicle, and/or to a remote server computer 140 (typically via direct radio frequency communications)). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 130 according to any suitable short-range communications mechanism (e.g., DSRC, cellular, or the like).

The network 135 represents one or more mechanisms by which a vehicle computer 110 may communicate with remote computing devices (e.g., the remote server computer 140, another vehicle computer, etc.). Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device (i.e., including one or more processors and one or more memories) programmed to provide operations such as disclosed herein. Further, the remote server computer 140 can be accessed via the network 135 (e.g., the Internet, a cellular network, and/or or some other wide area network).

The vehicle computer 110 is programmed to detect a key cycle. A key cycle engages the vehicle 105 between an on-state and an off-state. In examples herein, the key cycle typically engages the vehicle 105 from the on-state to the off-state and vice-versa. That is, upon detecting the key cycle, the vehicle computer 110 is programmed to transition the vehicle 105 between the on-state and the off-state. Each key cycle may be initiated by a user (e.g., turning a key in an ignition, by pressing a push-button, etc.). In an on-state, all vehicle components 125 and sensors 115 are available to be actuated by the vehicle computer 110 to operate the vehicle 105. In an off-state, the vehicle components 125 and sensors 115 are substantially powered off to conserve energy when the vehicle 105 is not in use.

Upon detecting the key cycle, the vehicle computer 110 is programmed to determine whether to enable or activate a standard operation mode based on an odometer value. The odometer value may be stored (e.g., in a memory of the vehicle computer 110). The odometer value specifies a distance traveled by the vehicle 105 after assembly. The vehicle computer 110 can actuate an odometer to determine a distance traveled by the vehicle 105 while the vehicle 105 is in the on-state. The vehicle computer 110 can update the odometer value based on the distance traveled while the vehicle 105 is in the on-state.

To determine whether to enable or activate the standard operation mode, the vehicle computer 110 compares the odometer value to a first odometer threshold. The first odometer threshold may be stored (e.g., in a memory of the vehicle computer 110). The first odometer threshold may be determined empirically (e.g., based on determining a maximum distance to be traveled by a vehicle while completing assembly plant evaluation procedures after assembly). If the odometer value is less than the first odometer threshold, then the vehicle computer 110 enables the standard operation mode. Upon enabling the standard operation mode, the vehicle computer 110 operates the vehicle 105 based on the default operating parameters. If the odometer value reaches, (i.e., is greater than or equal to) the first odometer threshold, the vehicle computer 110 disables the standard operation mode.

A standard operation mode specifies default operating parameters for the vehicle 105. The default operating parameters may be stored (e.g., in a memory of the vehicle computer 110). The default operating parameters may be determined empirically (e.g., based on testing and/or simulation data to determine operating parameters that satisfy vehicle performance requirements).

An operating parameter herein is a physical limit of vehicle 105 operation, i.e., an operating parameter specifies a limit of a measurement of vehicle operation and/or a measurement of an environmental condition limiting vehicle 105 operation. Put another way, an operating parameter is a limit of a measurement of a physical characteristic of a vehicle 105 or an environment around that vehicle 105 while the vehicle 105 is operating. A variety of operating parameters may be determined for vehicle operation. A non-limiting list of operating parameters includes a speed of the vehicle 105, a position of the vehicle 105 within a road and/or lane, a planned path of the vehicle 105, etc.

After enabling the standard operation mode based on the odometer value, the vehicle computer 110 can actuate the odometer to update the odometer value while the vehicle 105 is in the on-state, as discussed above. Upon determining that the odometer value reaches (i.e., equals or is greater than) the first odometer threshold, the vehicle computer 110 can transition the vehicle 105 to the second limited operation mode. That is, the vehicle computer 110 can disable the standard operation mode and enable or activate the second limited operation mode. In this situation, the vehicle computer 110 operates the vehicle 105 based on the second limited operating parameters, as discussed further below.

Upon disabling the standard operation mode based on the odometer value, the vehicle computer 110 is programmed to enable the first limited operation mode. The first limited operation mode specifies first limited operating parameters for the vehicle 105. The respective first limited operating parameters are less than the respective default operating parameters. The first limited operating parameters may be stored (e.g., in a memory of the vehicle computer 110). The first limited operating parameters may be determined empirically (e.g., based on determining maximum operating parameters typically required or used to operate the vehicle according to assembly plant and/or temporary holding facility site requirements). Upon enabling the first limited operation mode, the vehicle computer 110 operates the vehicle 105 based on the first limited operating parameters.

The vehicle computer 110 may be programmed to initiate a first timer upon enabling or activating the first limited operation mode. The first timer may have a predetermined duration (e.g., 30 seconds, 5 minutes, 10 minutes, etc.). The predetermined duration of the first timer may be determined empirically (e.g., based on determining an amount of time that is typically required for the vehicle 105 to traverse a specified route given the first limited operating parameters (e.g., between a temporary vehicle holding facility and a road that requires vehicle operation based on operating parameters greater than the first limited operating parameters). The predetermined duration of the first timer may be stored (e.g., in a memory of the vehicle computer 110) and then retrieved by the computer 110.

Upon expiration of the first timer, the vehicle computer 110 can transition the vehicle 105 to the second limited operation mode. That is, the vehicle computer 110 can disable the first limited operation mode and enable or activate the second limited operation mode. The second limited operation mode specifies second limited operating parameters for the vehicle 105. The respective second limited operating parameters are less than (i.e., values of limited parameters are less that value of) the respective default operating parameters and are greater (i.e., have greater values) than the respective first limited operating parameters. The second limited operating parameters may be stored (e.g., in a memory of the vehicle computer 110) for retrieval by the computer 110. The second limited operating parameters may be determined empirically (e.g., based on determining maximum operating parameters typically required or used to operate the vehicle between an assembly plant and a temporary holding facility). Upon enabling the second limited operation mode, the vehicle computer 110 operates the vehicle 105 based on (i.e., according to or using) the second limited operating parameters.

The vehicle computer 110 may be programmed to transition the vehicle 105 from the second limited operation mode to the first limited operation mode based on the odometer value reaching a second odometer threshold. For example, upon determining that the odometer value reaches the second odometer threshold while the vehicle 105 is operating in the second limited operation mode, the vehicle computer 110 can disable the second limited operation mode and enable the first limited operation mode. Additionally, the vehicle computer 110 can prevent transition to the second limited operation mode based on the odometer value being greater than or equal to the second odometer threshold when the first timer expires. In this situation, the vehicle computer 110 can maintain the vehicle 105 in the first limited operation mode; typically, the vehicle 105 can then be transitioned to the second limited authorized mode upon one or more additional events or triggers, such as the vehicle 105 being placed in a “Drive” gear or mode as opposed to “Park,” authentication of a user (e.g., as described further below), etc.

For example, in some implementations, after the odometer value reaches the second odometer threshold, before enabling or activating the second limited operation mode the vehicle 105 may further be required to be in a “Drive” gear or mode (e.g., so that if the vehicle 105 is part of a fleet of vehicles 105 being moved, all of the vehicle 105 in the fleet will not be placed in the second limited operation mode at a same time and there will be sufficient time to move the vehicle 105 and other respective vehicles 105 in the fleet).

Yet further alternatively or additionally, in some implementations, after the odometer value reaches the second odometer threshold, before enabling or activating the second limited operation mode, the computer 110 may perform a check for one or more blocking events. A “blocking event” in this context means detecting data or lack of data based on which the vehicle computer 110 is programmed to prevent or not enable or activate a limited operation mode. Example blocking events could include detecting a lack of data from a component such as an antenna, modem, or telematics unit typically needed for communication of data (diagnostic trouble codes or the like, status data, etc.), and/or detecting data (e.g., an unexpected door open event, unexpected movement, etc.) via the network 135 and/or to the server 140.

The second odometer threshold can be determined empirically (e.g., based on determining a maximum distance typically required for the vehicle to travel after assembly. For example, the distance could include a distance traveled at the assembly plant, between the assembly plant and a temporary vehicle storage facility, and/or at the temporary vehicle storage facility prior to being ready for shipment to a dealership or customer (i.e., to complete the manufacturer's evaluation process), and/or a distance travelled after delivery to a dealership or customer. The second odometer threshold can be stored (e.g., in a memory of the vehicle computer 110).

The vehicle computer 110 may be programmed to transition the vehicle 105 from the first limited operation mode (or the second limited operation mode) to the standard operation mode based on receiving a user input selecting the standard operation mode (e.g., via a human-machine interface (HMI) such as knobs, buttons, switches, pedals, levers, touchscreens, and/or microphones, etc.). The user input may be a single input (e.g., via selecting a virtual button via a touchscreen), or a sequence (i.e., a specified order) of a plurality of inputs (e.g., actuating one or more of knobs, buttons, switches, pedals, levers, etc.).

Upon receiving the user input, the vehicle computer 110 can initiate a second timer. Alternatively, the vehicle computer 110 can initiate the second timer after detecting a subsequent key cycle, as discussed below. The second timer may have a predetermined duration (e.g., 5 minutes, 10 minutes, 60 minutes, etc.). The predetermined duration of the second timer may be greater than the predetermined duration of the first timer. The predetermined duration of the second timer may be determined empirically or estimated. The empirical determination can include obtaining data and/or estimating a reasonable time for the vehicle to operate based on an amount of time that the vehicle may be operated without triggering a likelihood that the vehicle has been stolen and/or is being operated by an unauthorized user. For example, the empirical determination could be based on determining an average amount of time between enabling the standard operation mode (e.g., at a dealership) and operation of the vehicle (e.g., on a test-drive). The predetermined duration of the second timer may be stored (e.g., in a memory of the vehicle computer 110) and retrieved by the computer 110 The vehicle computer 110 may, for example, be programmed to transition the vehicle to the standard operation mode (i.e., enable or activate the standard operation mode) upon expiration of the second timer.

As another example, the vehicle computer 110 may be programmed to enable (or activate) the standard operation mode upon detecting a subsequent key cycle and expiration of the second timer. In a situation in which the second timer expires prior to the vehicle computer 110 detecting the subsequent key cycle, the vehicle computer 110 enables or activates the standard operation mode upon detecting the subsequent key cycle. That is, the vehicle computer 110 may prevent the first and second limited operation modes from being enabled. In a situation in which the second timer expires after detection of the subsequent key cycle, the vehicle computer 110 can transition the vehicle 105 from the first (or second) limited operation mode to the standard operation mode upon expiration of the second timer.

The vehicle computer 110 may be programmed to, upon detecting selection of the standard operation mode, enable the standard operation mode prior to expiration of the second timer (and/or prior to detecting the subsequent key cycle) based on detecting a presence of an authenticator. An authenticator herein means a device and/or information that permits override of the second timer expiration (and/or subsequent key cycle detection) prior to standard operation mode being enabled. Upon detecting the authenticator, the vehicle computer 110 can enable the standard operation mode (e.g., regardless of whether the second timer has expired and/or whether a subsequent key cycle has been detected). Upon detecting an absence of the authenticator, the vehicle computer 110 can delay enabling the standard operation mode (e.g., until the second timer has expired and/or the subsequent key cycle has been detected).

The authenticator may be a user input specifying a security code for the vehicle 105. Upon receiving the security code via the user input, the vehicle computer 110 can compare the received security code to a stored security code. If the received security code matches the stored security code, then the vehicle computer 110 determines the presence of the authenticator. If the received security code does not match the stored security code, then the vehicle computer 110 determines the absence of the authenticator.

The stored security code for the vehicle 105 may be determined as output from a random number generator. A “random number generator” is an algorithm that generates a sequence of numbers when seeded with an initial value. That is, the random number generator (RNG) is a deterministic algorithm that generates a specified sequence for each initial seed number; in the context of the present document, references to a random number generator are to what is understood in the computer 110 arts as a “pseudo-random number generator,” i.e., a number generator that generates a sequence of numbers based on an initial seed number. Said differently, the computer 110 can generate a sequence of random (or pseudorandom) numbers based on the initial seed number by using the RNG. The RNG can be a conventional algorithm (e.g., a Lehmer generator, a Mersenne Twister, an Advanced Randomization System, Philox, etc.). In this document, “seed” has its conventional meaning in the computer 110 arts, i.e., in the present context, to “seed” means specifying an initial condition of the RNG algorithm, which initializes the random number generator to generate a specific sequence of numbers based on the specific initial condition, i.e., seed value.

The vehicle computer 110 can, for example, input a vehicle identification number (VIN) and/or a date and time of completed assembly of the vehicle 105 into the random number generator as the seed value. As another example, the vehicle computer can input a current date and/or time into the random number generator as the seed value. The random number generator outputs a security code based on the seed value. The vehicle computer 110 can store the output security code (e.g., in a memory thereof). The vehicle computer 110 can then provide (e.g., by transmitting, via the network 135, a message including the stored security code and encrypted according to known data encryption techniques) the stored security code to a remote computer. As one example, a remote computer can be a portable device. A portable device can be any one of a variety of computers that can be used while carried by a person (e.g., a smartphone, a tablet, a personal digital assistant, a smart watch, a key fob, etc.).

As another example, the authenticator may be the portable device. For example, the vehicle computer 110 can detect the authenticator based on detecting the portable device within a predetermined distance of the vehicle 105. For example, the vehicle computer 110 can detect a portable device based on detecting the return of a radio frequency (RF) signal. Additionally, the vehicle computer 110 can receive location data from the portable device. Upon detecting the portable device, the vehicle computer 110 can compare a distance between the portable device and the vehicle computer 110 to the predetermined distance. The distance is typically a straight line or shortest distance between geo-coordinates specified by the location data of the portable device and geo-coordinates specified by the geo-fence for the vehicle 105. The predetermined distance specifies a maximum distance from a vehicle 105 within which the vehicle computer 110 can or is permitted to detect a portable device. The predetermined distance may be determined empirically (e.g., based on testing that allows for determining a distance from the vehicle 105 that indicates the detected portable device is likely to seek access to the vehicle 105) and/or estimated based on a prediction of how close a user carrying the portable device is likely to be to the vehicle when seeking to access the vehicle. The predetermined distance may be stored (e.g., in a memory of the vehicle computer 110) and retrieved by the computer 110. Upon determining that the portable device is within the predetermined distance, the vehicle computer 110 can determine the presence of the authenticator. Upon determining that the portable device is not within the predetermined distance, the vehicle computer 110 can determine the absence of the authenticator.

Additionally, or alternatively, the vehicle computer 110 can detect the authenticator based on determining that detected the portable device is authorized to communicate with the vehicle computer 110. The vehicle computer 110 may, for example, be programmed to determine that the portable device is authorized to communicate based on a key (e.g., a string of data such as a combination of numbers and/or characters) received from the portable device 140. For example, the vehicle computer 110 may authorize the portable device based on determining the received key matches an expected key (e.g., known to certain parties such as vehicle 105 distributors or dealers) stored in the memory of the vehicle computer 110. As another example, the vehicle computer 110 may authorize the portable device based on determining that a received security code matches the stored security code, as discussed above. As another example, the authorized portable device can have an RFID device or the like uniquely specifying the portable device from among other portable device. The RFID signal can be associated with the portable device in memory of the vehicle computer 110. Upon determining that the portable device is authorized to communicate with the vehicle computer 110, the vehicle computer 110 can determine the presence of the authenticator. Upon determining that the portable device is not authorized to communicate with the vehicle computer 110, the vehicle computer 110 can determine the absence of the authenticator.

As yet another example, the vehicle computer 110 can detect the authenticator based on a location of the vehicle 105. The vehicle computer 110 can determine the location of the vehicle 105 based on data (e.g., map data, received from, e.g., a remote server computer 140). For example, the vehicle computer 110 may receive a location of the vehicle 105 (e.g., from a sensor 115 a navigation system, the remote server computer 140, etc.). The vehicle computer 110 can compare the location of the vehicle 105 to the map data, to determine whether the vehicle 105 is within a predefined area (e.g., around an assembly plant, a temporary holding facility, etc.) specified in the map data. As another example, the vehicle computer 110 can determine the vehicle 105 is in the predefined area based on GPS-based geo-fencing. A geo-fence herein has the conventional meaning of a boundary for an area defined by sets of geo-coordinates. In such an example, the GPS geo-fence specifies a perimeter of a predefined area. The vehicle computer 110 can determine the vehicle 105 is in the predefined area based on the location data of the vehicle 105 indicating the vehicle 105 is within a geo-fence that specifies the predefined area. Upon determining that the vehicle 105 is within the predefined area, then vehicle computer 110 can determine the presence of the authenticator. Upon determining that the vehicle 105 is not within the predefined area, then vehicle computer 110 can determine the absence of the authenticator.

The vehicle computer 110 may be programmed to, upon receiving the user input selecting the standard operation mode, enable or activate the vehicle 105 to operate according to the standard operation mode. For example, based on detecting the absence of the authenticator, the vehicle computer 110 may maintain the vehicle 105 in the standard operation mode upon expiration of the second timer (and/or detection of the subsequent key cycle). In this situation, the vehicle computer 110 may prevent the first and second limited operation modes from being enabled (e.g., unless a user input is received re-enabling the first and second limited operation modes). Alternatively, based on detecting the presence of the authenticator, the vehicle computer 110 may re-initiate the second timer upon receiving a subsequent user input selecting the standard operation mode. In this situation, the vehicle computer 110 may determine whether to enable the standard operation mode or the first (or second) limited operation modes based on the odometer value and/or expiration of the first timer, as discussed above.

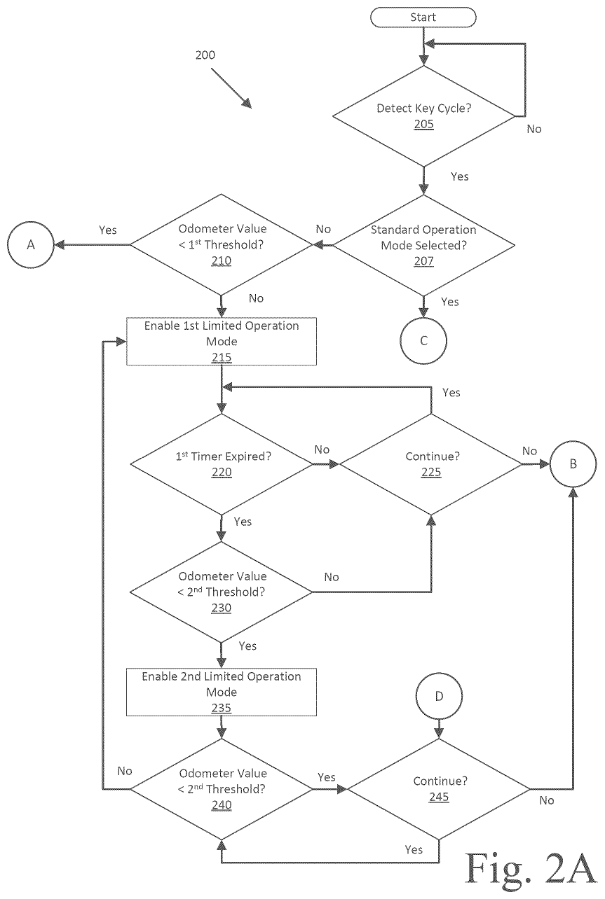

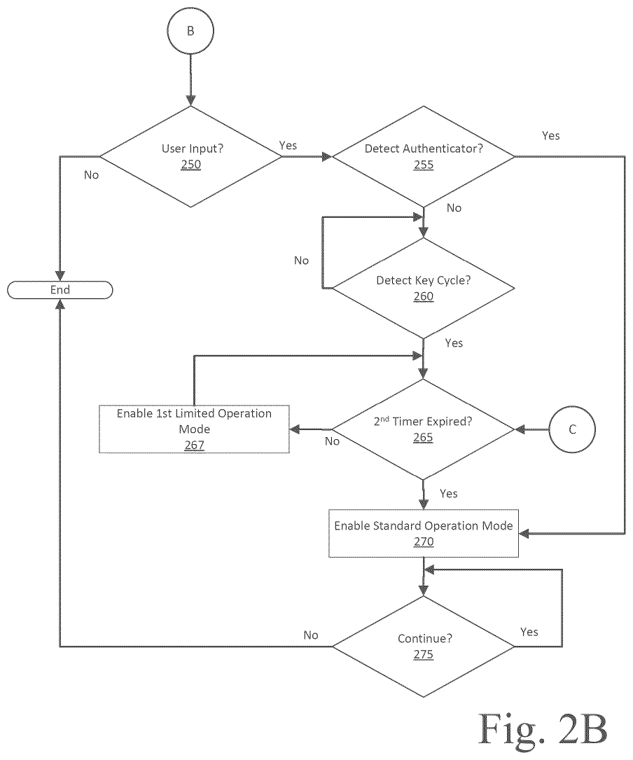

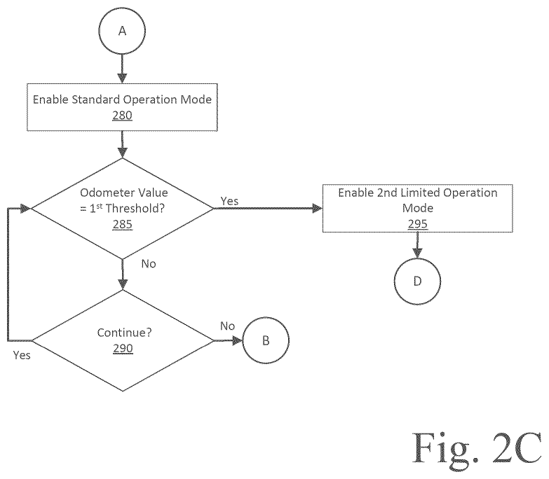

FIGS. 2A-2C (collectively, “FIG. 2)” comprise a diagram of an example process 200 for operating a vehicle 105. The process 200 begins in a block 205. The process 200 can be carried out by a vehicle computer 110 included in the vehicle 105 executing program instructions stored in a memory thereof.

In the block 205, the vehicle computer 110 determines whether a key cycle is detected. If the vehicle computer 110 detects the key cycle, then the vehicle computer 110 transitions the vehicle 105 from the off state to the on state, and the process 200 continues in a block 207. Otherwise, the process 200 remains in the block 205.

In the block 207, the vehicle computer 110 determines whether a standard operation mode has been selected. For example, the vehicle computer 110 can receive, prior to the detected key cycle and after detecting a previous key cycle, a user input selecting the standard operation mode. In this situation, the vehicle computer 110 can store (e.g., in a memory thereof) the selection of the standard operation mode. After detecting the key cycle in block 205, the vehicle computer 110 can access the memory to determine whether the selection of the standard operation mode is stored in the memory. If the selection of the standard operation mode is stored in the memory, then the process 200 continues in a block 265. Otherwise, the process 200 continues in a block 210.

In the block 210, the vehicle computer 110 determines whether an odometer value is less than a first odometer threshold. As discussed above, the vehicle computer 110 can actuate an odometer to update the odometer value while the vehicle 105 is operated in the on-state. The vehicle computer 110 compares the odometer value to the first odometer threshold. If the odometer value is less than the first threshold, then the process 200 continues in a block 280. Otherwise, the process 200 continues in a block 215.

In the block 215, the vehicle computer 110 enables the first limited operation mode. That is, the vehicle computer 110 operates the vehicle 105 based on the first limited operating parameters. The vehicle computer 110 is further programmed to initiate a first timer upon enabling the first limited operation mode. The process 200 continues in a block 220.

In the block 220, the vehicle computer 110 determines whether the first timer has expired. If the first timer has expired, then the process 200 continues in a block 230. Otherwise, the process 200 continues in a block 225.

In the block 225, the vehicle computer 110 determines whether to continue the process 200. For example, the vehicle computer 110 can determine to continue when the vehicle 105 is powered on. In another example, the vehicle computer 110 can determine not to continue when the vehicle 105 is powered off. In another example, the vehicle computer 110 can determine not to continue when a user input selecting the standard operation mode is received. If the vehicle computer 110 determines to continue, then the process 200 returns to the block 220. Otherwise, the process 200 continues in a block 250.

In the block 230, the vehicle computer 110 determines whether the odometer value is less than a second odometer threshold. As discussed above, the vehicle computer 110 can actuate an odometer to update the odometer value while the vehicle 105 is operated in the on-state. The vehicle computer 110 compares the odometer value to the second odometer threshold. If the odometer value is less than the second threshold, then the process 200 continues in a block 235. Otherwise, the process 200 continues in the block 225.

In the block 235, the vehicle computer 110 enables the second limited operation mode. That is, the vehicle computer 110 operates the vehicle 105 based on the second limited operating parameters. The vehicle computer 110 further disables the first limited operation mode. The process 200 continues in a block 240.

In the block 240, the vehicle computer 110 determines whether the odometer value is less than the second odometer threshold. The block 240 is substantially identical to the block 230, and therefore will not be described again to prevent redundancy. If the odometer value is less than the second threshold, then the process 200 continues in a block 245. Otherwise, the vehicle computer 110 disables the second limited operation mode, and the process 200 returns to the block 215.

In the block 245, the vehicle computer 110 determines whether to continue the process 200. The block 245 is substantially identical to the block 225, and therefore will not be described further to prevent redundancy. If the vehicle computer 110 determines to continue, then the process 200 returns to the block 240. Otherwise, the process 200 continues in the block 250.

In the block 250, the vehicle computer 110 determines whether a user input specifying selection of the standard operation mode is received. The vehicle computer 110 can receive the user input via an HMI, as discussed above. Upon receiving the user input, the vehicle computer 110 may initiate a second timer, as discussed above. If the vehicle computer 110 receives the user input, then the process 200 continues in a block 255. Otherwise, the process 200 ends.

In the block 255, the vehicle computer 110 determines whether an authenticator is detected. The vehicle computer 110 can detect a presence or an absence of the authenticator based on receiving data and/or a user input, as discussed above. If the vehicle computer 110 detects a presence of the authenticator, then the process 200 continues in a block 270. Otherwise, the process 200 continues in a block 260.

In the block 260, the vehicle computer 110 determines whether a subsequent key cycle is detected. The block 260 is substantially identical to the block 205, and therefore will not be described further to prevent redundancy. Upon detecting the subsequent key cycle, the vehicle computer 110 may initiate the second timer, as discussed above. If the vehicle computer 110 detects the key cycle, then the vehicle computer 110 transitions the vehicle 105 from the off state to the on state, and the process 200 continues in a block 265. Otherwise, the process 200 remains in the block 260.

In the block 265, the vehicle computer 110 determines whether the second timer has expired. If the second timer has expired, then the process continues in a block 270. Otherwise, the process 200 continues in a block 267.

In the block 267, the vehicle computer 110 enables the first limited operation mode. That is, the vehicle computer 110 operates the vehicle 105 based on the first limited operating parameters. Additionally, the vehicle computer 110 may initiate the first timer. In this situation, the vehicle computer 110 may transition to the second limited operation mode if the first timer expires prior to expiration of the second timer. The process 200 returns to the block 265.

In the block 270, the vehicle computer 110 enables the standard operation mode. That is, the vehicle computer 110 operates the vehicle 105 based on the default operating parameters. The process 200 continues in a block 275.

In the block 275, the vehicle computer 110 determines whether to continue the process 200. The block 275 is substantially identical to the block 225, and therefore will not be described further to avoid redundancy. If the vehicle computer 110 determines to continue, then the process 200 remains in the block 275. Otherwise, the process 200 ends.

In the block 280, the vehicle computer 110 enables the standard operation mode. That is, the vehicle computer 110 operates the vehicle 105 based on the default operating parameters. The process 200 continues in a block 285.

In the block 285, the vehicle computer 110 determines whether an odometer value equals the first odometer threshold. As discussed above, the vehicle computer 110 can actuate an odometer to update the odometer value while the vehicle 105 is operated in the on-state. If the odometer value equals the first threshold, then the process 200 continues in a block 295. Otherwise, the process 200 continues in a block 290.

In the block 290, the vehicle computer 110 determines whether to continue the process 200. The block 290 is substantially identical to the block 225, and therefore will not be described further to prevent redundancy. If the vehicle computer 110 determines to continue, then the process 200 remains in the block 285. Otherwise, the process 200 continues in the block 250.

In the block 295, the vehicle computer 110 enables the second limited operation mode. That is, the vehicle computer 110 operates the vehicle 105 based on the second limited operating parameters. The vehicle computer 110 further disables the standard operation mode. The process 200 continues in the block 245.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
detect a key cycle that transitions a vehicle from an off state to an on state;
disable a standard operation mode of the vehicle based on an odometer value being greater than or equal to a first threshold, wherein the standard operation mode specifies default operating parameters of the vehicle; and
upon disabling the standard operation mode of the vehicle, operate the vehicle in a first limited operation mode specifying first limited operating parameters, wherein the respective first limited operating parameters are less than the respective default operating parameters.

2. The system of claim 1, wherein the instructions further include instructions to, upon expiration of a timer, transition the vehicle to a second limited operation mode specifying second limited operating parameters, wherein respective second limited operating parameters are greater than the respective first limited operating parameters.

3. The system of claim 2, wherein the respective second limited operating parameters are less than the respective default operating parameters.

4. The system of claim 2, wherein the instructions further include instructions to initiate the timer upon detecting the key cycle.

5. The system of claim 2, wherein the instructions further include instructions to, after transitioning the vehicle to the second limited operation mode, transition the vehicle to the first limited operation mode based on the odometer value reaching a second threshold value.

6. The system of claim 5, wherein the vehicle is transitioned to the first limited operation mode only upon the vehicle being placed in a “Drive” mode.

7. The system of claim 2, wherein the instructions further include instructions to, after transitioning the vehicle to the second limited operation mode, block transitioning the vehicle to the first limited operation mode upon a blocking event being detected when the odometer value has reached a second threshold value.

8. The system of claim 2, wherein the instructions further include instructions to prevent operation of the vehicle in the second limited operation mode based on the odometer value reaching a second threshold value.

9. The system of claim 1, wherein the instructions further include instructions to, upon detecting the key cycle, enable the standard operation mode of the vehicle based on the odometer value being less than the first threshold.

10. The system of claim 9, wherein the instructions further include instructions to, after enabling the standard operation mode, transition the vehicle to the second limited operation mode based on the odometer value reaching the first threshold.

11. The system of claim 1, wherein the instructions further include instructions to, after enabling the first limited operation mode, enable the standard operation mode based on receiving a user input selecting the standard operation mode, on detecting a subsequent key cycle, expiration of a second timer, the second timer being initiated upon receiving the user input, and/or a location of the vehicle being within a predetermined area.

12. A method comprising:
detecting a key cycle that engages a vehicle from an off state to an on state;
disabling a standard operation mode of the vehicle based on an odometer value being greater than or equal to a first threshold, wherein the standard operation mode specifies default operating parameters of the vehicle; and
upon disabling the standard operation mode of the vehicle, operating the vehicle in a first limited operation mode specifying first limited operating parameters, wherein the respective first limited operating parameters are less than the respective default operating parameters.

13. The method of claim 12, further comprising, upon expiration of a timer, transitioning the vehicle to a second limited operation mode specifying second limited operating parameters, wherein respective second limited operating parameters are greater than the respective first limited operating parameters.

14. The method of claim 13, wherein the respective second limited operating parameters are less than the respective default operating parameters.

15. The method of claim 13, further comprising, upon detecting the key cycle, initiating the timer, enabling the standard operation mode of the vehicle based on the odometer value being less than the first threshold.

16. The method of claim 13, further comprising, after transitioning the vehicle to the second limited operation mode, transitioning the vehicle to the first limited operation mode based on the odometer value reaching a second threshold value.

17. The method of claim 16 wherein the vehicle is transitioned to the first limited operation mode only upon the vehicle being placed in a “Drive” mode.

18. The method of claim 13, further comprising preventing operation of the vehicle in the second limited operation mode based on the odometer value reaching a second threshold value.

19. The method of claim 18, further comprising, after enabling the standard operation mode, transitioning the vehicle to the second limited operation mode based on the odometer value reaching the first threshold.

20. The method of claim 12, further comprising, after enabling the first limited operation mode, enabling the standard operation mode based on receiving a user input selecting the standard operation mode, on detecting a subsequent key cycle, expiration of a second timer, the second timer being initiated upon receiving the user input, and/or a location of the vehicle being within a predetermined area.
